(19) United States
(12) Patent Application Publication
(10) Pub. No.: US 2022/0268008 A1
(43) Pub. Date: Aug. 25, 2022

(54) MODULAR RAIN GARDEN SYSTEM

(71) Applicant: SUSAN ILLMAN, Cheltenham (GB)

(72) Inventor: SUSAN ILLMAN, Cheltenham (GB)

(21) Appl. No.: 17/629,528

(22) PCT Filed: Jul. 23, 2020
(86) PCT No.: PCT/EP2020/070792

§ 371 Date: Jan. 24, 2022

(30) Foreign Application Priority Data
Jul. 24, 2019 (GB) 1910568.3

(51) Int. Cl. E03F 1/00; E03F 5/10

(52) U.S. Cl. CPC E03F 1/005; E03F 5/101; E03F 5/106

(57) ABSTRACT

The invention provides a modular rain garden system comprising a plurality of preformed channel sections 310 and two end panels 320. The channel section 310 and end panels 320 are configured to form a trough 300 when assembled to receive rainwater runoff. At least one end of the channel section has an engaging profile configured to engage with another channel section or one of the end panels. Divider panels 330 are provided to separate the trough into compartments, to provide additional strength or rigidity to the trough or to control or limit the flow of water between compartments. The side walls 312 of the channel sections, the end panel 320 and the divider panels 330 are corrugated by means of projections or grooves 313, 321 and 331 respectively to increase the strength and load-bearing capability of the components.

### TECHNICAL FIELD

The present invention relates to rain gardens, which are used to intercept, attenuate and temporarily store rain water runoff, usually in urban areas having impervious surfaces such as roads, driveways, pavements, roofs and the like.

### BACKGROUND

Storm water drainage in cities is a current challenge for urban planners and engineers. In many urban areas, the existing drainage infrastructure was built for a different era and population. The need for car parking for example, results in many suburban front gardens being paved over, adding to water runoff in storm events to an already overburdened drainage system.

Scientists also predict an increase in heavy rain fall events in the coming decades, raising the likelihood of severe and damaging flooding in cities.

Current initiatives to reduce run off tend to be bespoke, are limited in impact, and expensive to install, requiring considerable engineering input. Replacing underground drainage pipes for larger higher capacity pipes can be highly disruptive to communities, and prohibitively expensive.

Excavating small rain gardens in paved surfaces, to intercept, attenuate and store rain water in engineered surrounds is problematic due to the load bearing and structural requirements of such surfaces. Rain gardens in soft landscape areas can also cause problems with soil erosion and ground stability.

At the same time, there is great resistance from the highways engineering profession for water to be collected within the soil adjacent to highways, due to the potential for destabilisation of the road kerbs and edgings. Those approving new build schemes, also express concerns over the potential desiccation of soils where trees are planted in relatively close proximity to buildings, and have imposed onerous standards that restrict or prohibit their use.

A need exists for an improved design of rain garden which can be mass-produced, which is scalable for different sites, and which can be simply and comparatively easily installed within both new developments and existing streets as well as domestic gardens to help intercept, attenuate and store water runoff, thus easing pressure on the drainage systems in the vicinity, and reducing the potential incidence of surface water flooding.

At the same time, the ability to maximize the benefits of ‘managing water on the surface’ (to fulfil a need for development to be more sustainable) requires all parts of water management schemes to also improve water and air quality, provide a more biodiverse system and contribute to the visual amenity of urban spaces.

### SUMMARY OF THE INVENTION

According to the invention, a modular rain garden system is provided comprising a plurality of modules, each in the form of a channel section, at least one end of the channel section having an engaging profile configured to engage with a part of another like module so that the modules are configured to be assembled to one another to define an elongate trough for receiving rainwater runoff, and end panels arranged to close the ends of the trough.

The channel section is preferably of substantially U-shaped section.

In one preferred embodiment, one end panel is formed integrally with the respective channel section and the other end panel is formed separately from the respective channel section and engageable with the respective channel section to form the trough. In another embodiment, both end panels are formed separately from the channel section.

In either case, the end panel which is formed separately from the channel section preferably has an engaging profile configured to engage with the channel section. The engaging profile of the channel section and/or the end panel may comprise a simple overlap joint, a flange joint or any other suitable form of joint. Preferably, the engaging profile comprises an interlocking profile to form an interlocking joint with the other component. In a preferred embodiment, the interlocking profile comprises corresponding vertically-running grooves/projections which engage with one another by relative vertical movement.

The system preferably further includes a perforated drainage pipe to receive and transport the rainwater runoff out of the trough. At least one of the end panels may be provided with a removable section to provide an aperture for the drainage pipe to exit the trough.

In preferred embodiments, the channel section and/or the end sections are provided with a horizontal flange on the upper edge for bedding into surround material in use.

As mentioned above, the channel section is preferably substantially U-shaped. Preferably, the channel section comprises a bottom wall and two side walls projecting upwards from the bottom wall. The side walls may project perpendicularly to the bottom wall or they may project at an angle greater than 90 degrees relative to the bottom wall. This will facilitate stacking of a plurality of identical channel sections.

Preferably, the side walls are corrugated (e.g. by means of grooves or projections) to provide increased load-bearing strength. The end sections may be similarly corrugated.

The bottom wall is preferably provided with inwardly-extending projections to provide a void space between the projections which acts as a reservoir at the bottom of the trough.

The projections will serve to space the material above in the trough from the bottom wall so that the space can be filled with water. The system is configured so that this reservoir is not drained from the trough (e.g. by the perforated pipe, which in preferred embodiments will rest on the projections also) but will instead be available to sustain plant life in the trough in dry spells.

The modular rain garden system may further include one or more divider panels to separate the trough into compartments. The projections on bottom wall of the channel section mentioned above may be used to locate and retain the divider panels in position. The divider panels preferably slot into grooves provided in the side walls of the channel sections.

Divider panels may be employed to provide additional strength or rigidity to the trough. They may also or instead be employed to control or limit the flow of water between compartments, for example if the trough is employed on sloping ground. In one embodiment, the divider panels are permeable and are provided with apertures to permit the flow of water between compartments. Such divider panels may be employed when the trough is used on level ground. In another embodiment, the divider panels are substantially impermeable and act as weir walls between compartments. These may be used when the trough is employed on sloping ground. In either embodiment, the divider panels may be corrugated by means of grooves or projections to provide increased load-bearing strength.

Weir plates may also be employed at the joint of two channel sections to provide unimpeded water storage capacity above the top of the trough in most sloping ground applications. Such weir plates would sit above the internal weir walls, and in most applications be fixed within the surrounding walls.

The modular system preferably comprises a plurality of preformed channel sections and two end plates. The system is therefore readily configurable into a trough of the desired length and capacity for the particular installation. Preferably, the plurality of preformed channel sections are identical in all significant respects and are configured to be nestable/stackable to reduce the volume required for transportation and storage. Similarly, the end panels may be configured to be nestable/stackable.

The various components of the modular rain garden system may be formed from any suitable material. The material is preferably generally impermeable, and at least in the case of the modules and end plates will typically be a plastics material. Preferably, the components are formed from recycled and/or recyclable material.

No proprietary product currently exists for this application. This invention is designed to create a “plug and play” rain garden for retro-installation in existing locations or incorporated into plans for new-build areas. The invention allows engineers to fit rain gardens more quickly, with predictable results, be easy to maintain, and provide a beautiful and functional aesthetic in-street and in-garden designs.

The modular rain garden system may be supplied with specific soil mixture and plants for planting within the rain garden, suited to the application. Such planters would have many advantages beyond their primary purpose as it is well known that soft planting in urban areas has multiple beneficial impacts on surrounding communities.

As discussed above, the modular rain garden system may optionally incorporate an integral storage reservoir and wicking to provide reserve irrigation, to sustain plant life in dry spells. The main channel section may be capable of being used individually or be locatable with other body sections with a joining mechanism and will allow for suitable interfaces with existing drainage pipes. The modular rain garden system may be formed with reinforceable walls and allow for drop in weir plates and storm water baffles, allowing the system to be used in sloping applications. The design may incorporate provision for adjacent kerb support. The modular rain garden system is designed with the horticultural requirements of resilient plant material in mind.

At least in preferred embodiments, the invention may provide:
A preformed rain garden planter;
A planter designed to inter-locate or connect to adjoining planters;
A preformed planter incorporating a built-in reservoir for sustaining plant life;
A preformed impermeable planter to contain water and soil media;
A preformed planter constructed to incorporate both impermeable and permeable boundaries;
A preformed planter for installing into hard surfaces, to reduce storm water runoff from multiple sources;
A preformed planter for installing in soft landscape and garden areas, to accept water flows from roofs or multiple hard surfaces;
A preformed planter designed to allow for structural reinforcement around its perimeter to support adjacent load bearing surfaces;
A preformed rain garden planter with an integral reservoir and wicking fabric to sustain plant life;
A preformed rain garden planter with provision to install a weir plate or similar, to disperse flow and reduce water energy, thus preventing soil erosion during flood conditions;
A preformed rain garden with provision to add reinforcing panels to support increased structural and lateral loadings;
A preformed rain garden with provision to add impermeable weir walls to allow controlled water flow on a gradient;
A preformed rain garden with provision to add weir plates to allow water to be attenuated above the top of the trough to a managed level;
A modular preformed rain garden liner, with the ability to join with other similar modules to increase the capacity of storm water managed within the planter;
A modular preformed planter, incorporating a controlled orifice or orifices, for water discharge thus regulating onward flow to drains;
A modular rain garden system incorporating a scalable preformed liner, and ancillary products including as an example but not exclusively: end panels, weir walls, reinforcing panels, piping, joining means, soil media, mulch and plants.
A modular preformed rain garden planter, with an overflow means to avoid prolonged water logging of the soil media within;
A modular rain garden designed to nest or inter-stack for economical freight; and
A modular rain garden formed from recycled and/or recyclable material.

### BRIEF DESCRIPTION OF THE DRAWINGS

Embodiments of the invention will now be described by way of example only and with reference to the accompanying drawings, in which:

FIG. 1 shows a plan view of a typical installation for a modular rain garden system in accordance with the invention;

FIG. 2 shows a section view of the installation of FIG. 1 along line 2-2;

FIG. 3 shows an isometric view of an embodiment of a modular rain garden system in accordance with the invention;

FIG. 4 shows a perspective view of another embodiment of a modular rain garden system in accordance with the invention;

FIG. 5 shows a perspective view of a further embodiment of a modular rain garden system in accordance with the invention;

FIG. 6 shows a perspective view of a channel section and end panel for use in the invention;

FIG. 7 shows a perspective view of an end panel for use in the invention;

FIG. 8 shows a perspective view of an alternative end panel for use in the invention;

FIG. 9 shows a perspective view of a unitary channel section and end panel for use in the invention; and

FIG. 10 illustrates, diagrammatically, an arrangement including a weir plate.

### DETAILED DESCRIPTION OF PREFERRED EMBODIMENTS

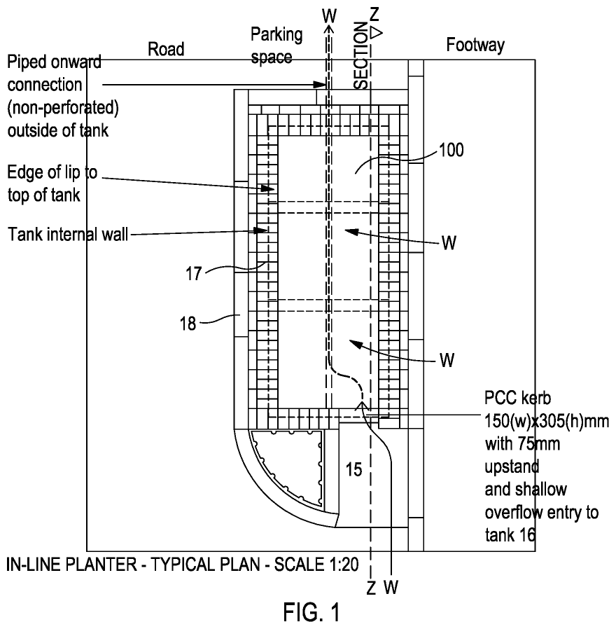

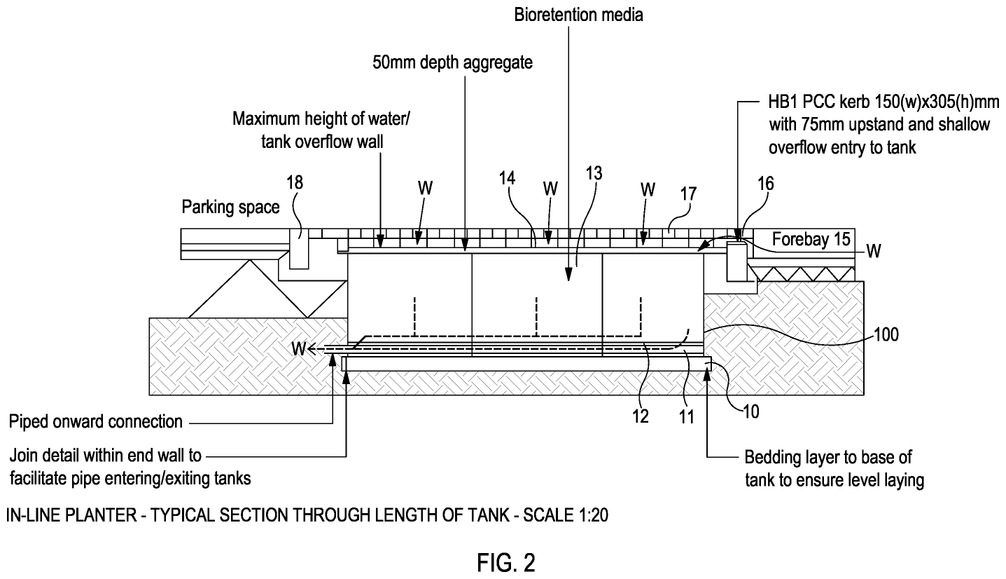

With reference to FIGS. 1 and 2, a typical urban installation for a modular rain garden system in accordance with the invention is shown. The location is a planted bed adjacent a line of parking spaces on a road. The tank or trough formed by the modular rain garden system is shown generally as 100 and will be described in more detail with reference to the other figures below. In terms of this example installation, the tank or trough 100 is sunk into a hole which is lined at the bottom with a bedding layer 10. The trough 100 has an internal perforated pipe 11 and a grid layer 12, above which the trough is filled with bioretention media 13, such as soil media. A 50 mm layer of aggregate 14 forms the top layer.

A forebay 15 is provided to control the flow of water into the trough 100 and act as a silt and debris filter. A pre-cast concrete kerb 16 provides an overflow lip (75 mm in this example), over which the water W passes when there is a high enough flow of water into the forebay, for example during persistent or heavy rain. Water W may also pass into the trough from other routes, such as from the footway or from roadside inlets where the number of units is greater. The water incident on the trough is initially collected on the surface, and within the aggregate 14, then flows down through the bioretention media 13 and grid layer 12 to the perforated pipe 11, from which it flows out of the trough into a non-perforated pipe for onward connection to the drainage system. Paving stones 17 and kerbs 18 are provided around the edge of the trough 100 to protect the trough and provide an appropriate solid surface.

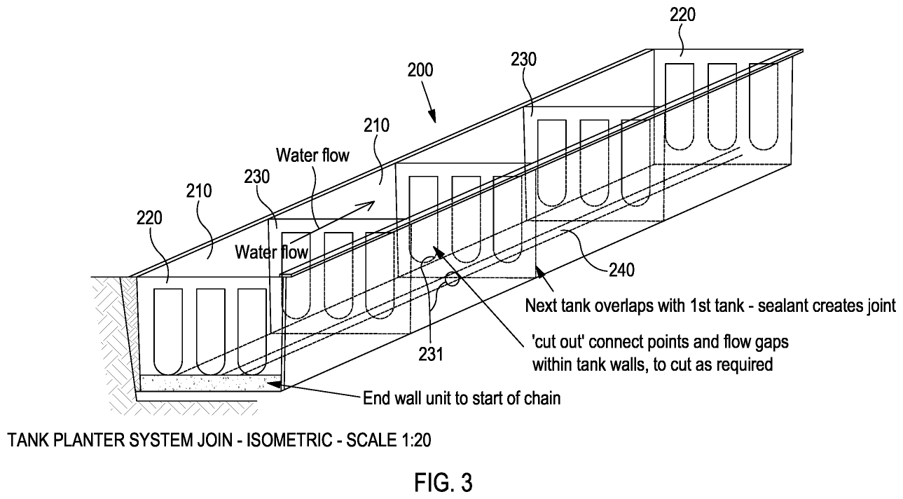

FIG. 3 shows an isometric view of a trough 200 formed by an embodiment of a modular rain garden system in accordance with the invention. Trough 200 is formed from a plurality of modular channel sections 210, in this case four such sections 210, and two end panels 220. Divider plates 230 are also provided to separate the trough into separate compartments. A perforated pipe 240 runs the length of the trough and collects the incident water for onward supply to the drainage network. The divider plates 230 have a cut-out 231 for the pipe but may otherwise be impermeable or permeable depending on the specific requirements of the installation. The joins between the channel sections 210 are simple overlapping joints which can be made water-tight by using sealant, if desired.

The use of a pipe 240 to conduct water to a remote location may not always be required. Depending upon the underlying geology, perforations may be provided in the bottom wall of the trough 200 through which water can escape for infiltration into the ground.

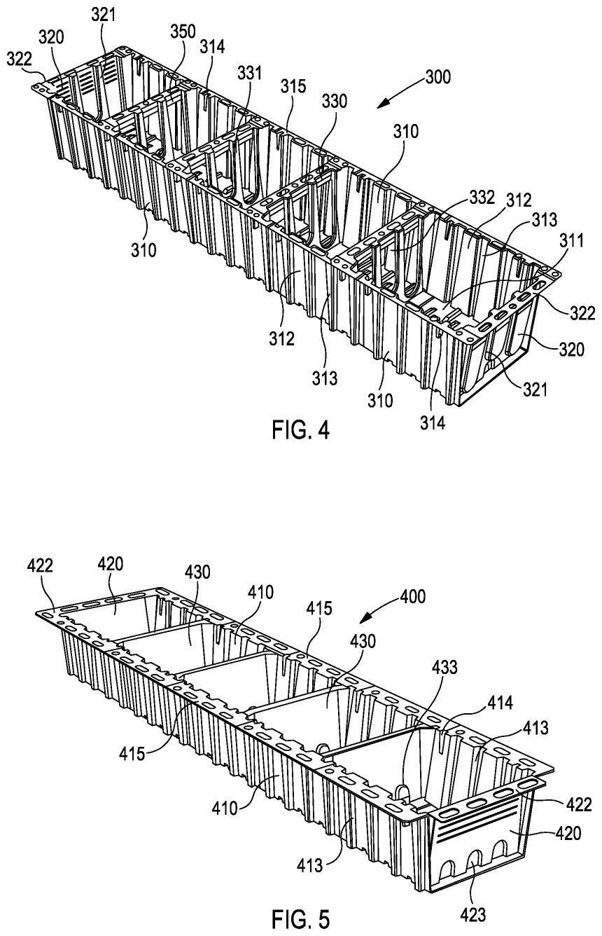

FIG. 4 shows a perspective view of a trough 300 formed by another embodiment of a modular rain garden system in accordance with the invention. Trough 300 is formed from modular channel sections 310, each having a bottom wall 311 and side walls 312, and two end panels 320 fitted to the end ones of the sections 310. Divider plates 330 are provided to separate the trough into compartments, the divider plates in this embodiment being permeable by means of apertures 332. The divider plates 330 in this embodiment provide additional reinforcement to the structure. The join between the channel sections 310 is an interlocking joint of the type described below. Channel section side walls 312, end panels 320 and divider plates 330 are corrugated by means of projections or grooves 313, 321 and 331 respectively to increase the strength and load-bearing capability of the components. Side walls 312 are also provided with short grooves 314 at their upper edges for additional rigidity. Horizontal flanges 315 and 322 are respectively provided on the side walls 312 and end panels 320 for bedding into surround material in use.

FIG. 5 shows a perspective view of a trough 400 formed by another embodiment of a modular rain garden system in accordance with the invention. Trough 400 is formed from modular channel sections 410 and two end panels 420. Divider plates 430 are provided to separate the trough into compartments, the divider plates in this embodiment being generally impermeable to form weir walls.

End panels 420 and divider plates 430 are provided with removable sections or blanking panels 423 and 433 respectively which can be selectively removed to provide apertures to accommodate a drainage pipe (not shown).

The join between the channel sections 410 is an interlocking joint of the type described below. Grooves 413 and short grooves 414 are provided in channel section side walls 412, similar to the FIG. 4 embodiment, to increase strength, and horizontal flanges 415 and 422 are provided for bedding into surround material in use.

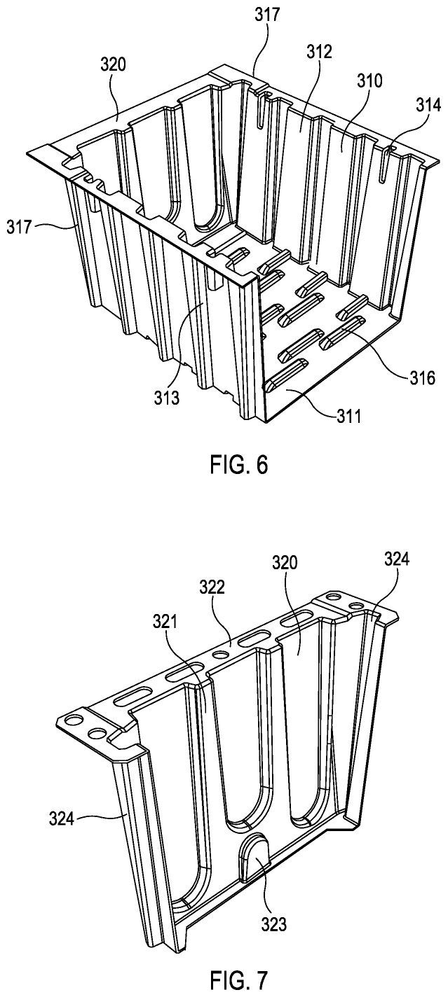

FIGS. 6 and 7 show perspective views of a channel section and end panel for use in the invention, similar to the embodiment of FIG. 4. The same features are given the same reference numbers. In this arrangement, each channel section 310 is closed at one end and is open at its other end. Upon assembly of the channel sections 310 to one another to form an elongate trough, it will be appreciated that the closed end of an end one of the channel sections 310 defines an end panel 320, and that the remaining closed ends each define a respective divider plate 330. The other end of the trough is closed by a separate end panel 320 of the form shown in FIG. 7. As shown in FIG. 7, the separate end panel 320 includes a removable section or blanking panel 323 which can be selectively removed to provide an aperture to accommodate a drainage pipe. In addition, these figures show bottom wall 311 being provided with inwardly-extending projections 316 to provide void spaces between the projections which act as a reservoir at the bottom of the trough 300. In other embodiments, the bottom wall 311 and/or the projections 316 may be perforated to enable water to drain through to the soil below. Such perforations will typically only be provided where infiltration into the underlying ground can be used. Elsewhere, no such perforations will be provided and the bottom wall 311 will typically be solid to prevent the underlying impermeable geology being softened by water.

These figures also show the method of interlocking engagement between the end panel 320 and the channel section 310. End panel 320 is provided with a projection profiles 324 which engage with the reinforcing grooves shown specifically as 317. The end panel 320 is slid down vertically into engagement with the channel section 310 and this makes a sufficiently water-tight join without the need for sealant.

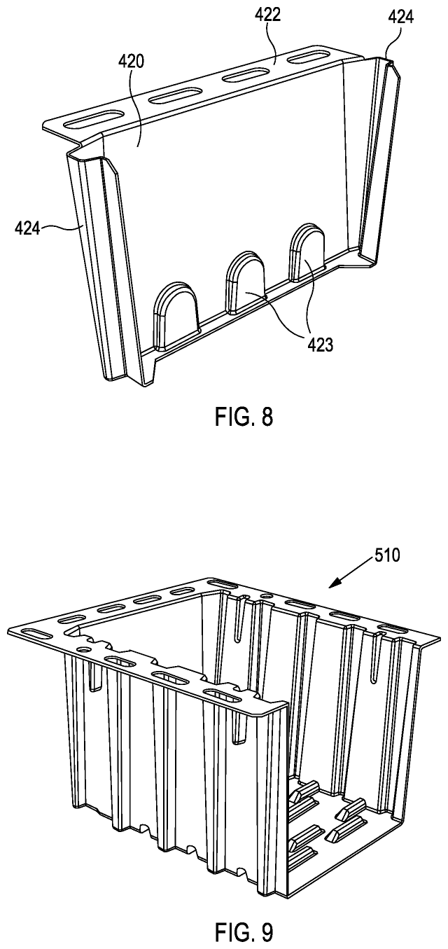

FIG. 8 shows an alternative embodiment of end panel 420, similar to the FIG. 5 embodiment type, including horizontal flange 422 and removable sections or blanking panels 423 to provide apertures to accommodate a drainage pipe (not shown). The interlocking engagement is the same as explained for FIGS. 6 and 7 above, with projections 424 engaging with grooves 317 of the channel section.

FIG. 9 shows a perspective view of a unitary channel section and end panel 510 for use in the invention, in which the end panel is integral with the channel section. Apart from this difference, the arrangement is very similar to that of the arrangement of FIG. 6 and similar features will be identifiable.

In the arrangements described hereinbefore, the upper edge of the trough is intended to be located below the level of the surrounding ground surface. By way of example, one or more layers of bricks, kerbstones or the like may surround the periphery of the trough. A void is thus defined above the trough. In use, in the event of heavy rain or the like a quantity of rainwater will collect within the void defined above the trough.

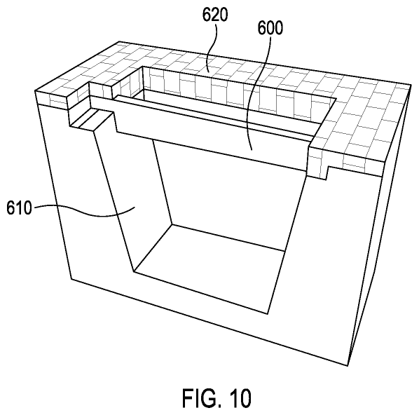

As shown in FIG. 10, one or more weir plates 600 may be provided. The weir plates 600 may be of, for example, concrete form, and are designed to extend across the width of the trough 610 and to project above the level of the trough 610 so as to extend across the width of the void 620 above the trough 610. Whilst the height of the weir plate 600 could be such that it extends over the full height of the void 620, this need not be the case and FIG. 10 illustrates an arrangement in which it is of height extending over only part of the height of the void 620. The purpose of the weir plate 600 is to attenuate water flow along the void 620. If desired, the weir plates 600 may be installed in positions arranged to align with the divider plates, but this need not be the case.

It will be appreciated that the weir plates of FIG. 10 may be employed with any of the arrangements described hereinbefore.

Channel sections 210, 310 and 410 as well as unitary channel section and end panel 510 are designed to be stackable within each other to reduce the volume required for transportation and storage. Similarly, the same design of end panel may be stackable.

1. A modular rain garden system comprising a plurality of modules, each in the form of a channel section, at least one end of the channel section having an engaging profile configured to engage with a part of another like module so that the modules are configured to be assembled to one another to define an elongate trough for receiving rainwater runoff, and end panels arranged to close the ends of the trough.

2. The modular rain garden system of claim 1, wherein the channel section is of generally U-shaped form.

3. The modular rain garden system of claim 1, wherein one end panel is formed integrally with the channel section and the other end panel is formed separately from the channel section and engageable with the channel section to form the trough.

4. The modular rain garden system of claim 1, wherein both end panels are formed separately from the channel section.

5. The modular rain garden system of claim 3, wherein the separately formed end panel also has an engaging profile configured to engage with the channel section.

6. The modular rain garden system of claim 1, wherein the engaging profile comprises an interlocking profile.

7. The modular rain garden system of claim 6, wherein the interlocking profile comprises corresponding vertically-running grooves and projections which engage with one another by relative vertical movement.

8. The modular rain garden system of claim 1, further including a perforated drainage pipe to receive and transport the rainwater runoff out of the trough.

9. (canceled)

10. The modular rain garden system of claim 1, wherein at least one of the channel section and the end sections is provided with a horizontal flange on the upper edge for bedding into surround material in use.

11. The modular rain garden system of claim 1, wherein the channel section comprises a bottom wall and two side walls projecting upwards from the bottom wall, and the side walls are corrugated to provide increased load-bearing strength.

12. The modular rain garden system of claim 1, wherein the channel section comprises a bottom wall and two side walls projecting upwards from the bottom wall, and the bottom wall is provided with inwardly-extending projections to provide a void space between the projections which acts as a reservoir at the bottom of the trough.

13. The modular rain garden system of claim 12, further including a material which in use rests on the projections and maintains the void space between the projections.

14. The modular rain garden system of claim 12, wherein at least one of the bottom wall and the projections is provided with perforations to facilitate drainage to the soil below.

15. The modular rain garden system of claim 1, further including at least one divider panel to separate the trough into compartments.

16. (canceled)

17. The modular rain garden system of claim 15, wherein the divider panels are provided with apertures to permit the flow of water between compartments.

18. The modular rain garden system of claim 15, wherein the at least one divider panel is substantially impermeable and act as weir walls between compartments.

19. The modular rain garden system of claim 15, wherein the at least one divider panel is corrugated to provide increased load-bearing strength.

20. The modular rain garden system of claim 1, comprising a plurality of channel sections.

21. The modular rain garden system of claim 20, wherein the channel sections have the same configuration and are stackable.

22. (canceled)

23. The modular rain garden system of claim 1, and further comprising a permeable grid layer located within the trough and supported in a substantially horizontal orientation at a position spaced above the base of the trough.

24. (canceled)
